(19) United States
(12) Patent Application Publication
(10) Pub. No.: US 2010/0007064 A1
(43) Pub. Date: Jan. 14, 2010

(54) APPARATUS AND METHOD FOR MANUFACTURING HOLLOW TUBULAR MEMBERS

(76) Inventor: Clint H. Ashton, Manti, UT (US)

Correspondence Address: KARL R CANNON, PO BOX 1909, SANDY, UT, 84091, US

(21) Appl. No.: 12/420,018

(22) Filed: Apr. 7, 2009

Related U.S. Application Data
(63) Continuation of application No. 12/008,830, filed on Jan. 14, 2008.
Application No. 12/008,830 is a continuation of application No. 11/818,724, filed on Jun. 15, 2007, now abandoned.
Application No. 11/818,724 is a continuation of application No. 11/649,739, filed on Jan. 3, 2007, now abandoned.
Application No. 11/649,739 is a continuation of application No. 11/517,807, filed on Sep. 8, 2006, now abandoned.
Application No. 11/517,807 is a continuation of application No. 11/402,217, filed on Apr. 10, 2006, now abandoned.

(51) Int. Cl. B29C 49/44; B29C 49/00; B29C 49/20; B29C 49/06; B29C 49/28

(52) U.S. Cl. 264/506; 264/571; 264/523; 425/522; 425/533

(57) ABSTRACT

A method of forming hollow tubular members may include providing a mold defining a surface corresponding to a configuration of the hollow tubular member. A fabric material may be placed in the mold for bonding with a resin to form the hollow tubular member. A bladder may be placed in the mold next to the fabric material to form a substantially air tight region around the fabric material. A pump may be used to apply a sub-atmospheric pressure in the substantially air tight region and thereby press the fabric material against the mold. The sub-atmospheric pressure may also be used to draw the resin material into the mold in contact with the fabric material. Once the resin and fabric material have adequately cured, the hollow tubular member may be removed from the mold.

### CROSS-REFERENCE TO RELATED APPLICATIONS

This application is a continuation of prior application Ser. No. 12/008,830, filed Jan. 14, 2008, which is a continuation of application Ser. No. 11/818,724, filed Jun. 15, 2007, which is a continuation of application Ser. No. 11/649,739, filed Jan. 3, 2007, which is a continuation of application Ser. No. 11/517,807, filed Sep. 8, 2006, which is a continuation of application Ser. No. 11/402,217, filed Apr. 10, 2006, which claims the benefit of U.S. Provisional Application No. 60/669,767, filed Apr. 8, 2005, which are hereby incorporated by reference herein in their entireties, including but not limited to those portions that specifically appear hereinafter, the incorporation by reference being made with the following exception: In the event that any portion of the above-referenced application are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention

The present disclosure relates generally to devices and methods for manufacturing tubular members, and more particularly, but not necessarily entirely, to devices and methods for manufacturing composite hollow tubular members, such as columns.

2. Description of Related Art

Hollow tubular members, such as architectural columns, have been made of materials such as wood, steel or concrete for years. Architectural columns, such as upright pillars or posts are commonly used to support roofs or beams, or they may be purely decorative and not intended to provide primary structural support. Classical columns may be built according to the Classic Orders of Architecture as recorded in the late 1500's by the Renaissance architect, Vignola. The classical column designs include the Doric, Ionic, and Corinthian designs, for example. These designs are constructed to specific mathematical proportions and may have a series of flutes extending along the length of the columns. The flutes may terminate at an end point on the bottom of the column before reaching the column base. The flutes may also terminate at an end point near the top of the column before reaching the capital of the column. The flutes may also be mathematically proportioned with respect to astragals, or convex moldings, that may be positioned near the top and bottom of the columns. Other hollow tubular members may be formed with a smooth exterior surface without any flutes or ridges.

Also, some architectural column designs, such as the Greco-Roman architectural column design, for example, may be tapered. A lower third of the Greco-Roman architectural column may be characterized by an absence of substantial taper, or perhaps a slight draw at the most. A middle third and an upper third may include exterior surfaces which may be tapered by a continuous radially inward taper extending from a first entasis point to an upper end such that the middle third may be characterized by one-third of the total taper and the upper third may be characterized by two-thirds of the total taper. However, the specific proportions of taper may vary.

Materials such as wood, steel, or concrete can be used to make hollow tubular members, such as the classical design columns having flutes. For example, wood columns may be constructed by forming flutes in the surface with a router. Concrete columns with flutes may be formed by pouring concrete into molds. However, tubular members made of materials such as wood, steel, or concrete are known to have various drawbacks. Wood columns are prone to decay and crack or split over time which reduces the structural integrity and aesthetic appearance of the columns. Moreover, measures must be taken in the installation of wood columns to allow the wood columns to breathe. This adds to the costs and complexity of construction with wood columns. Columns made of concrete or steel are heavy and may be difficult and expensive to construct and handle.

Tubular members made of a composite of fiber-reinforced bonding agent provide the advantages of light weight structures that are corrosion resistant. However, it has been difficult to manufacture columns of composite material that also have the taper, flutes and terminal portions of the flutes, or that are otherwise economical to construct. For example, tubular members made using a filament winding process have had difficulties forming suitable flutes in columns. Moreover, considerable manufacturing equipment may be required for filament winding composite tubular members, including winding machines, rotisserie curing machines, extracting machines to remove the tubular members from mandrels, sanding machines and finishing machines. This equipment may be relatively expensive, which may add to the cost of producing the tubular members.

Attempts have been made to form composite columns by pouring a slurry of resin and fillers, such as chopped glass, talc and magnesium, into molds using a centrifugal casting process. The molds may then be spun to force the slurry materials against an interior surface of the molds. The centrifugal casting process may also require equipment that may be expensive to obtain and operate. Moreover, fluted tubular members formed with the centrifugal casting process may have shallow flutes that may not be constructed in accordance with classical design, since deep flutes may be difficult to construct using the centrifugal casting process.

Attempts have also been made to construct composite hollow tubular members, such as columns, by forming halves of the columns in molds and then gluing the halves together. Columns having configurations in accordance with classical designs may be formed in this manner, however, it may be difficult and time consuming to precisely align the column halves to be adhered together. Moreover, the columns constructed in this manner are formed with a joint which may be unsightly and may cause a weakening in the column.

The prior art is thus characterized by several disadvantages that are addressed by the present invention. The present invention minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a side view of a hollow tubular member made in accordance with the principles of the present disclosure;

FIG. 2 is a cross-sectional view of the tubular member of FIG. 1, taken along section A-A;

FIG. 3 is a side view of an alternative embodiment hollow tubular member made in accordance with the principles of the present disclosure;

FIG. 4 is a cross-sectional view of the tubular member of FIG. 3, taken along section B-B;

FIG. 5 is an exploded view of structure for forming a tubular member in accordance with the principles of the present disclosure;

FIG. 6 is a schematic perspective view of structure for forming a tubular member in accordance with the principles of the present disclosure;

FIG. 7 is a break-away cross-sectional view of an embodiment of structure for forming a tubular member showing a bladder connected to a mold; and

FIG. 8 is an exemplary flow chart depicting steps which may be used as part of a method of forming a hollow tubular member in accordance with the principles of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. Moreover, in describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “tubular members” shall be construed broadly to include members of various shapes, and shall not be restricted to cylindrical shaped members. The tubular members may be hollow to define a passage extending through an interior of the tubular member, or the tubular members may be formed without a continuous through passage.

As used herein, the phrase “sub-atmospheric pressure” shall be construed broadly to include a partial vacuum or reduced or negative pressures with respect to an adjacent atmospheric pressure, or other base or reference pressure.

As used herein, the phrase “substantially air tight region” shall be construed broadly to include regions that may be enclosed sufficiently to create a sub-atmospheric pressure, including regions that may not be completely air tight.

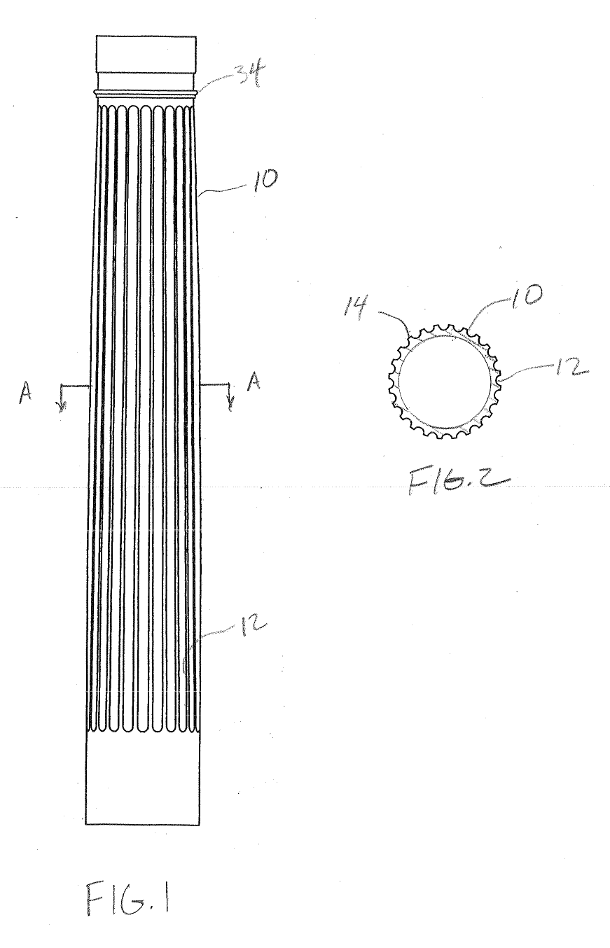

Referring now to FIG. 1, a side view is shown of an exemplary embodiment hollow tubular member 10. The hollow tubular member 10 is shown as a column having flutes 12 or decorative grooves formed in the exterior surface of the hollow tubular member 10. It will be understood, that the hollow tubular member 10 may be formed as any variety of objects in addition to columns, such as poles, including flag poles or light poles for example, or pipes, or any other such member known to those skilled in the art.

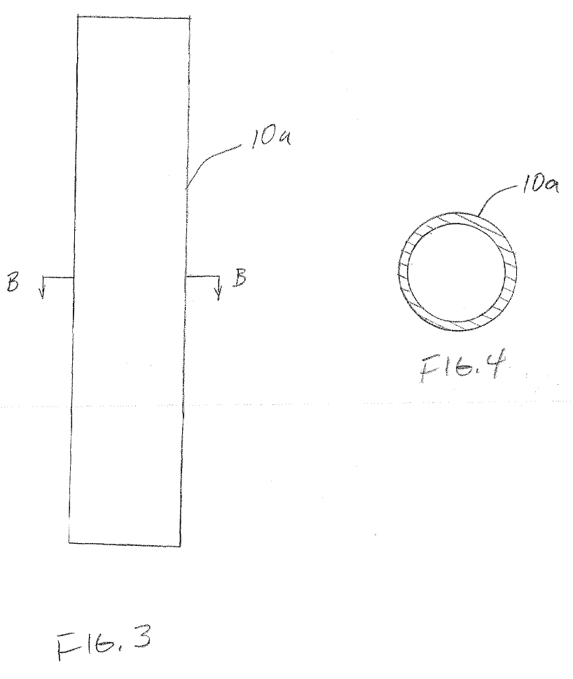

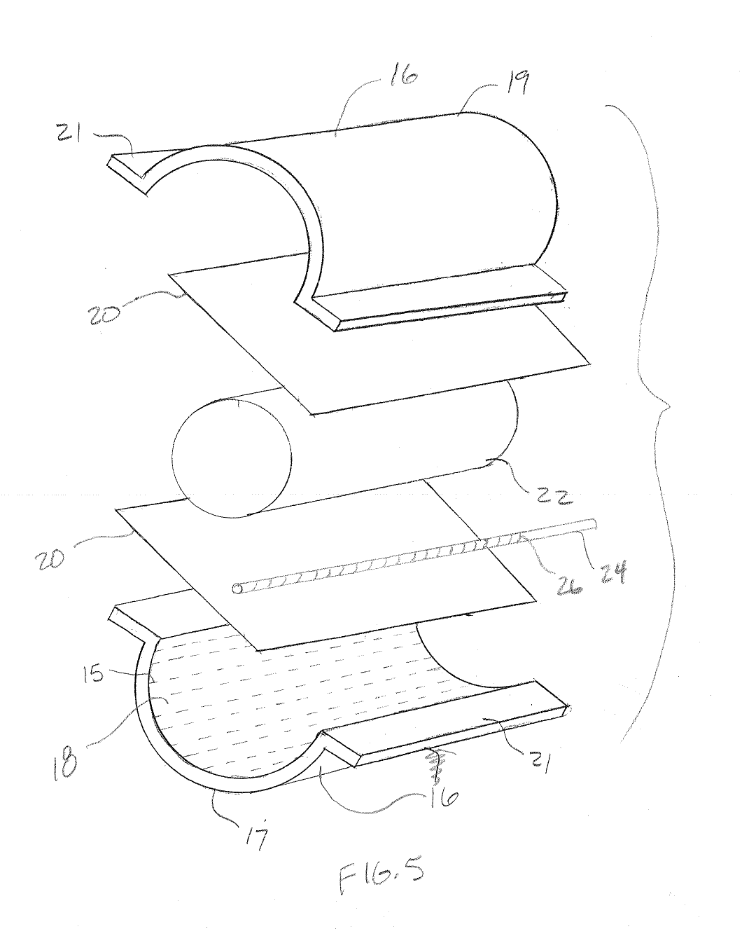

The flutes 12 may extend lengthwise along the hollow tubular member 10. The flutes 12 may have various different shapes and configurations. For example, the flutes 12 may be curved and spaced apart to form a series of plateaus 14 between the flutes 12, as shown most clearly in FIG. 2, which shows a cross-section of the tubular member 10, taken along line A-A. Alternatively, the flutes 12 may have an angular configuration (not shown) in which the portions between the flutes may be somewhat pointed, or the portions between the flutes may be curved. It will also be appreciated that the flutes 12 may be formed in other shapes and in various sizes and quantities within the scope of the present disclosure. Other decorative features in addition to or instead of flutes may also be formed on the hollow tubular member 10. Moreover, it will be understood that a hollow tubular member 10a may be formed in accordance with the principles of the present disclosure, without flutes, as shown most clearly in FIGS. 3 and 4. It will be understood that as used herein, reference to the hollow tubular member 10 refers to the hollow tubular member in general, which also applies to the alternative embodiment hollow tubular member 10a, and other relevant embodiments of the hollow tubular member that are not shown, unless the context clearly dictates otherwise.

The hollow tubular member 10 may be formed with any shaped cross-section, such as a rounded or circular shape, as shown in FIGS. 2 and 4. It will also be understood that the hollow tubular member 10 may formed in various other cross-sectional shapes, such as oval, square, polygonal, or non-uniform shapes, for example, within the scope of the present disclosure. Also, the hollow tubular members 10 may be formed in various different lengths and having various different thicknesses within the scope of the present disclosure. Moreover, the hollow tubular members 10 may be open at opposing ends such that a through passage may be formed in the hollow tubular member 10, or the tubular member 10 may be formed without a through passage.

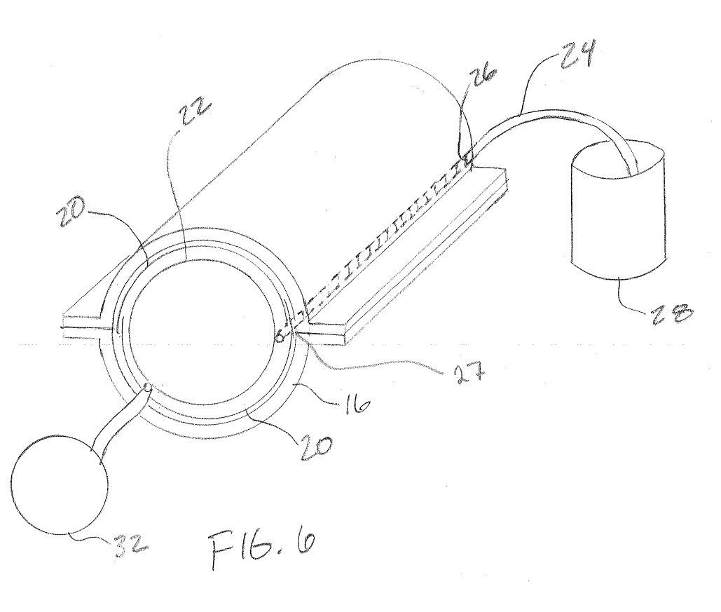

Referring now to FIG. 5, a method for manufacturing hollow tubular members 10 will now be described. A mold 16 may be provided defining a surface 18 corresponding to a configuration of the hollow tubular member 10. Accordingly, the surface 18 may be smooth or alternatively, the surface 18 may include features 15, as shown in dashed lines in FIG. 5, for forming the flutes 12, or other decorative or functional portions of the tubular members 10. The mold 16 may be formed in any suitable manner known to those skilled in the art and the mold may be provided in multiple pieces that may be joined together. For example, as shown in FIG. 5, the mold 16 may be provided in two pieces that may be joined together in any manner known in the art. The mold 16 may include a first portion 17 corresponding to a first portion of the hollow tubular member 10, and a second portion 19 corresponding to a second portion of said hollow tubular member 10. The first portion 17 of the mold 16 and the second portion 19 of the mold 16 may be configured to be removably joined together to form the hollow tubular member 10 in a single piece. It will be understood that the mold 16 may have other quantities of components, or the mold 16 may be a one piece mold within the scope of the present disclosure.

One embodiment of the mold 16 may include flanges 21 on the first portion 17 of the mold 16 and the second portion 19 of the mold 16. The flanges 21 may provide an area for joining the first portion 17 of the mold 16 to the second portion 19 of the mold 16, and the flanges 21 may also provide support to the mold 16. Clamps or other fastening means may be attached to the flanges 21 to hold the components of the mold 16 together. Sealant is spread along the faces of flanges 21, such as urethane, silicone, pvc foam or any suitable compressible seal, before the flanges 21 are clamped together to make an airtight seal. Other embodiments of the mold 16 of the present disclosure may be formed without flanges 21. For example, an edge of the first portion 17 of the mold 16 may join with an edge of the second portion 19 of the mold in a tongue and groove, or other abutting arrangement, and a belt or strap (not shown) may encompass the mold 16 to maintain the components of the mold 16 attached together. It will also be understood that any other of a variety of connection mechanisms known to those skilled in the art may be used to join the first portion 17 of the mold 16 with the second portion 19 of the mold 16.

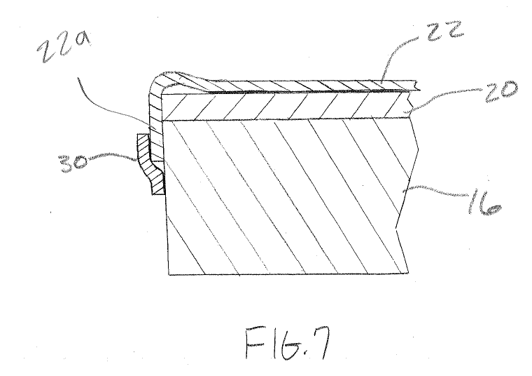

One embodiment of the mold 16 may form a continuous surface along a cross-section of the mold 16, such as a rounded or circular shape, as shown most clearly in FIG. 6. Moreover, the mold 16 may have various other cross-sectional shapes corresponding to the cross-sectional shape of the hollow tubular member 10, such as oval, square, polygonal, or non-uniform shapes, for example. One embodiment of the mold 16 may be open at opposing ends such that an interior of the mold 16 may be accessible from each end, and such that the mold 16 may be configured to form a hollow tubular member 10 that may also be open at both ends.

The mold 16 may be formed of a material suitable to provide adequate strength, rigidity and durability to the mold 16. Also, the mold 16 may be formed of a material that may allow the tubular member 10 to be released from the mold 16 without causing damage to the tubular member 10. It will also be understood that various types of surface treatments known in the art may be applied to the surface 18 of the mold 16 to prevent the tubular member 10 from sticking to the surface 18 of the mold 16.

A fabric material 20 may be placed in the mold 16. The fabric material 20 may be made of a material for bonding with a resin to form a composite material. For example, the fabric material may be a fiberglass or chopped glass material, or any other suitable material known in the art. The fabric material 20 may be provided in flexible sheets or strips, in various different sizes and thicknesses, that may be capable of deforming to conform to the shape of the inner surface 18 of the mold 16. Moreover, the fabric material 20 may be cut or resized to fit a specified size. One embodiment of the fabric material 20 may be formed so as to allow a resin to flow and spread through the fabric material 20. Thus, the fabric material 20 may be permeable to the resin material such that the resin material may be dispersed throughout the fabric material 20. The fabric material 20 may be held in place in the mold 16 by gravity in the bottom or first portion 17 of the mold 16. Also, any suitable attaching mechanism known to those skilled in the art, such as tape, adhesives, straps, or supports, for example, may be used to hold the fabric material 20 in place in either the first portion 17 or second portion 19 of the mold 16.

A bag or bladder 22 may also be placed in the mold 16 such that the fabric material 20 may be positioned between the mold 16 and the bladder 22. The bladder 22 may be formed of a flexible material or membrane which may be allowed to expand or otherwise deform, as discussed below, to assist in pressing the fabric material 20 against the mold 16. The bladder 22 may be shaped so as to cover the surface 18 of the mold 16, and to conform to any features 15 on the surface 18 of the mold 16. Accordingly, the bladder 22 may take on various different configurations, and the bladder 22 as depicted in the drawings is presented in schematic form and is not intended to be limiting of the configuration of the bladder 22. One embodiment of the bladder 22 may be formed of a tubular plastic film, such as a cylindrical bag that may be open at both ends. The bladder 22 may be able to lay in a flat configuration in a relaxed condition, and thereafter be inflated, expanded, or deformed to conform to the surface 18 of the mold 16. Accordingly, the bladder 22 may be formed without rigidity such that the bladder 22 does not remain in any specified configuration in a relaxed state, rather, the bladder 22 may be deformable. Other embodiments of the bladder 22 may be formed as an enclosed member having air confined in the interior of the bladder 22, or the bladder 22 may be formed with sufficient rigidity to remain in a specified configuration in a relaxed condition.

One or more pipes 24 may be inserted in the mold 16 between the bladder 22 and the inner surface 18 of the mold 16. The pipe 24 may serve as a conduit for introducing resin into the mold 16. In one embodiment, the pipe 24 may be a flexible member configured to bend to conform to a desired position within the mold 16. The pipe 24 may be positioned within the mold 16 so as to extend in a direction substantially parallel to a longitudinal axis of the mold 16, or the pipe 24 may be positioned in other orientations within the scope of the present disclosure. The pipe 24 may have a helical slot 26 extending along a portion of the pipe 24 which may be positioned within the mold 16. The slot 26 may allow resin transported by the pipe 24 to pass from the pipe 24 into the mold 16. It will be understood that other embodiments of the pipe 24 may include slots or apertures in various different configurations within the scope of the present disclosure. For example, the pipe 24 may include a plurality of apertures or perforations (not shown) spaced around the circumference of the pipe and along the length of the pipe. The apertures may be elongated slots or rounded openings, for example.

One end of the pipe 24 may be placed in a resin source, such as a container 28, as shown in FIG. 6. It will be understood that the container 28 may be provided as any suitable device known in the art for holding a resin material. It will also be understood that a plurality of containers 28 may be used. An opposing end of the pipe 24 may terminate within the mold 16. One embodiment of the pipe 24 may be configured to extend a majority length of the mold 16 to facilitate dispersion of the resin material along the length of the mold 16. A point of entry of the pipe 24 within the mold 16 may be sealed to the mold 16 and/or the bladder 22 to maintain a substantially air tight region for receiving the fabric material 20 and the resin material. It will be understood that any of a variety of adhesive tapes, seals or gasket mechanisms known in the art may be used to seal the point of entry of the pipe 24 into the mold 16.

Molds 16 having a plurality of components, such as a first portion 17 and a second portion 19, may be joined together in any manner known to those skilled in the art. The bladder 22 may also be attached to the mold halves 17 and 19 such that a substantially air tight region may be formed between the bladder 22 and the mold 16 (i.e. mold halves 17 and 19) where the fabric material 20 may be located. Accordingly, the bladder 22 may be attached to the mold 16 at both ends. In one embodiment, as shown in the enlarged break-away cross-sectional view depicted in FIG. 7, a portion 22a of the end of the bladder 22 itself may be attached to the mold 16 using adhesive tape 30, for example. It will be understood that other varieties of attaching mechanisms, seals or gaskets may be used to attach the bladder 22 to the mold 16 to form the substantially air tight region.

It will also be understood that the fabric material 20 may overlap on an interior side of the mold 16 without causing visible aberrations on exterior of the hollow tubular member 10 when construction of the hollow tubular member is complete. The overlapping of the fabric material 20 may form a thickening of the side wall of the hollow tubular member 10 that may be visible from an interior of the hollow tubular member 10. However, an exterior surface of the hollow tubular member 10 may conform to the inner surface 18 of the mold without any apparent joints caused by overlapping the fabric material 20.

A suction pump 32, shown schematically in FIG. 6, may be attached to the substantially air tight region to evacuate air and create a sub-atmospheric pressure in the substantially air tight region. The suction pump 32 may include a piston-vacuum pump, or any variety of pump or vacuum known to those skilled in the art for moving air and creating a sub-atmospheric pressure. The sub-atmospheric pressure within the substantially air tight region may cause the bladder 22 to expand or deform to press against the fabric material 20 such that the fabric material 20 may conform to the shape of the inner surface 18 of the mold 16. Moreover, the sub-atmospheric pressure may also be used to draw resin through the pipe 24 and the slot 26 such that the resin may come into contact with the fabric material 20. The resin may flow through the fabric material 20 and combine with the fabric material 20 to form a composite material of fiber reinforced bonding agent to form the hollow tubular member 10. The hollow tubular member 10 may thus be formed of a lightweight material having excellent strength and durability characteristics.

Suitable resin materials may include epoxies, polyesters, polyimides, silicones, polyethylenes, and phenolics or any other such resin known to those skilled in the art for combining with the fabric material 20 to form a composite material. The particular resin used may be selected to be suitable for the intended purpose based on various factors such as cost, strength, durability, fire retardation characteristics, or appearance, for example. Moreover, the resin may also be colored as desired with a suitable dye to produce a hollow tubular member 10 with an aesthetically pleasing appearance.

Once the combination of resin material and fabric material forming the hollow tubular member 10 has adequately cured, the mold 16 may be separated, if a multi-part mold is used, and the hollow tubular member 10 may be removed from the mold 16. If necessary, burrs or other surface aberrations may be removed from the hollow tubular member with an abrasive material or other such method known to those skilled in the art. A burr may be formed where the first portion 17 of the mold 16 joins with the second portion 19 of the mold 16, which may be easily removed with an abrasive material. Such a burr 27 that forms at the junction between the first portion 17 of the mold 16 and the second portion 19 of the mold 16 may not be considered to be a joint in the hollow tubular member 10, since the fabric material 20 forming the hollow tubular member 10 may extend continuously along the hollow tubular member 10 between the first portion 17 of the mold 16 and the second portion 19 of the mold 16. Thus, the strength of the hollow tubular member 10 is as great at the junction between the first portion 17 of the mold 16 and the second portion 19 of the mold 16 as at other portions of the hollow tubular member 10. Accordingly, the hollow tubular member 10 may be formed as a one-piece member without any seams or joints where multiple parts of the hollow tubular member 10 have been connected together.

Also, any variety of mechanized equipment known in the art, such as trimming machines, grinders or sanders, may be used to place the hollow tubular member 10 in a finished configuration. The hollow tubular member 10 may also be painted or otherwise finished with a desired color or surface treatment in a manner known to those skilled in the art.

The present method may allow the proper amount of resin to be applied to the fabric material 20 without waste. For example, since the resin material may pass to the mold 16 through the pipe 24 in an enclosed environment, very little of the resin may be spilled. Moreover, the substantially air tight region where the resin is to be applied may be enclosed such that excess resin material may not fit within the mold 16 and over-application of resin material may be prevented. Accordingly, the present method may be economical as compared to prior art methods. Moreover, the equipment required for use with the present method may be relatively inexpensive as compared to some prior art methods. Also, the present method may allow the resin to be introduced in an enclosed area such that the generation of harmful fumes may be greatly reduced. This may improve the environmental conditions at the manufacturing site as well as the health and safety conditions for individuals associated with the manufacturing of the hollow tubular members 10. Furthermore, the present method may allow hollow tubular members 10 to be constructed efficiently in accordance with specific requirements, such as the specific shapes and mathematical proportions of classical column designs.

It will also be understood that the hollow tubular member 10 may have other features, such as an astragal 34, as shown in FIG. 1. The astragal 34 may include a convex molding or beading around the circumference of the hollow tubular member 10. The astragal 34 may be formed as part of the hollow tubular member 10 in a manner similar to the flutes 12, by way of features 15 on the inner surface 18 of the mold 16. Alternatively, the astragal 34 or other features such as a capital at an upper end of the hollow tubular member 10, or a base at the lower end of the hollow tubular member 10, may be added to the hollow tubular member 10. In one embodiment, structures such as the astragal 34 may be cast or injection molded onto the hollow tubular member 10. Alternatively, structures such as the astragals 34 may be formed independently and joined with the hollow tubular member 10 as a separate piece. It will be understood that various different portions or structures may be joined with the hollow tubular member 10 using various different techniques known to those skilled in the art, within the scope of the present disclosure.

It will also be understood that an alternative embodiment of the present disclosure may include a bladder 22 that may be enclosed such that the bladder 22 may be inflated to thereby expand and press the material 20 against the mold 16. Moreover, the resin may be injected into the mold 16 using any of a variety of techniques known to those skilled in the art. Accordingly, an alternative embodiment may not require the formation of a sub-atmospheric pressure or a substantially air tight region between the mold 16 and the bladder 22.

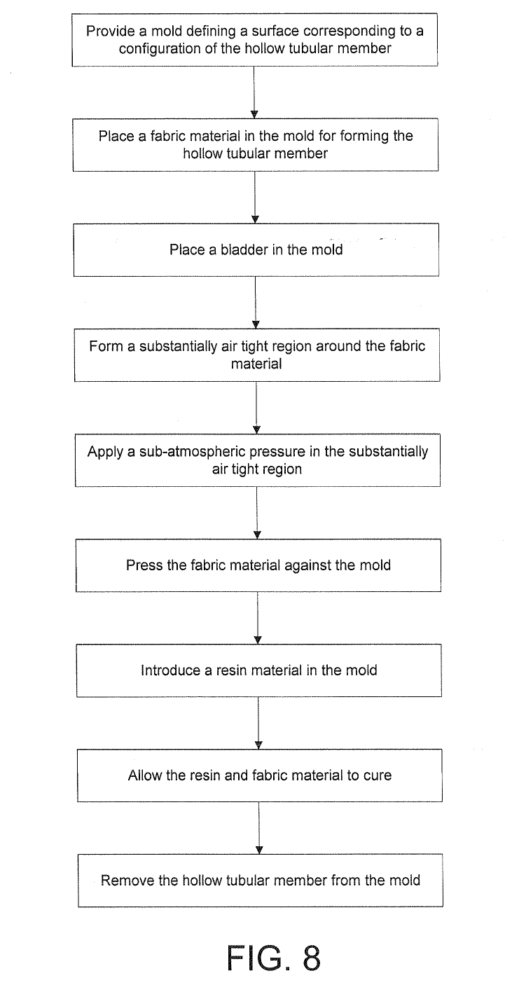

Referring to FIG. 8, an exemplary flow chart is depicted including steps that may be utilized in manufacturing a hollow tubular member 10. It will be understood that the steps depicted in FIG. 8 are for illustrative purposes only, and that some embodiments of the present disclosure may not include all of the steps depicted in FIG. 8. Likewise, other embodiments of the present disclosure may include additional steps not shown in FIG. 8. As described in FIG. 8 for example, and in accordance with the features and combinations described above, a useful method of forming a hollow tubular member may include:

(a) Providing a mold defining a surface corresponding to a configuration of the hollow tubular member; Optional: Spraying a gel coat on the interior surface of the mold, for the purpose of causing a surface texture and/or color to the exterior surface of the part being manufactured;

(b) Placing a fabric material in the mold for forming the hollow tubular member;

(c) Placing a bladder in the mold;

(d) Forming a substantially air tight region around the fabric material;

(e) Applying a sub-atmospheric pressure in the substantially air tight region;

(f) Pressing the fabric material against the mold;

(g) Introducing a resin material in the mold;

(h) Allowing the resin and fabric material to cure; and

(i) Removing the hollow tubular member from the mold.

Those having ordinary skill in the relevant art will appreciate the advantages provided by the features of the present disclosure. For example, it is a feature of the present disclosure to provide a method and apparatus for forming a hollow tubular member which is simple to use. Another feature of the present disclosure is to provide such a method and apparatus for forming a hollow tubular member which is economical and can avoid the need for expensive equipment. It is a further feature of the present disclosure, in accordance with one aspect thereof, to provide a method and apparatus for forming a hollow tubular member which is versatile such that it can be used to form either tubular members having a smooth exterior surface, or tubular members with flutes or other features in accordance with shapes and mathematical proportions of classical column designs. It is an additional feature of the present disclosure to provide a method and apparatus for forming hollow tubular members which allows for reduced generation of harmful vapors. It is a further feature of the present disclosure to provide a method and apparatus for forming hollow tubular members which allows the hollow tubular members to be formed without seams or joints created by attaching multiple pieces together.

It will be appreciated that the structure and apparatus disclosed herein is merely one example of a means for pressing a fabric material, and it should be appreciated that any structure, apparatus or system for pressing a fabric material which performs functions the same as, or equivalent to, those disclosed herein are intended to fall within the scope of a means for pressing a fabric material, including those structures, apparatus or systems for pressing a fabric material which are presently known, or which may become available in the future. Anything which functions the same as, or equivalently to, a means for pressing a fabric material falls within the scope of this element.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim.

Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A method of forming a hollow tubular member, said method comprising:
(a) providing a mold defining a continuous surface open at opposing ends corresponding to a configuration of said hollow tubular member;
(b) placing a material in said mold for forming said hollow tubular member;
(c) applying a sub-atmospheric pressure in said mold to press said material against said mold and draw a resin material into said mold.

2. The method of claim 1, further comprising providing said mold in a plurality of components, said plurality of components being configured to be joined together.

3. The method of claim 1, wherein the step of placing a material in said mold comprises placing a fabric material in said mold.

4. The method of claim 1, further comprising placing a bladder in said mold.

5. The method of claim 4, further comprising joining said bladder with said mold to form a substantially air tight region around said material.

6. The method of claim 5, wherein said sub-atmospheric pressure is applied to said substantially air tight region.

7. The method of claim 6, wherein applying said sub-atmospheric pressure in said mold to press said material against said mold comprises expanding said bladder.

8. The method of claim 1, further comprising placing a pipe in said mold adjacent said material for introducing said resin material into said mold.

9. The method of claim 1, further comprising allowing said material and said resin material to cure to form said hollow tubular member.

10. The method of claim 9, further comprising removing said hollow tubular member from said mold.

11. The method of claim 1, further comprising forming at least one flute in said hollow tubular member.

12. A method of forming a hollow tubular member, said method comprising:
(a) providing a mold defining a surface corresponding to a configuration of said hollow tubular member;
(b) placing a material in said mold for forming said hollow tubular member;
(c) placing a bladder in said mold;
(d) expanding said bladder to press said material against said mold.

13. The method of claim 12, further comprising applying a sub-atmospheric pressure in said mold to expand said bladder and press said material against said mold.

14. The method of claim 12, further comprising introducing a resin material in said mold to combine with said material to form said tubular member.

15. The method of claim 12, further comprising joining said bladder with said mold to form a substantially air tight region around said material.

16. The method of claim 12, further comprising placing a pipe in said mold adjacent said material for introducing a resin material into said mold.

17. The method of claim 12, further comprising forming at least one flute in said hollow tubular member.

18. A method of forming a hollow tubular member, said method comprising:
(a) providing a mold comprised of a plurality of components joined together to define an interior surface corresponding to an exterior surface of said hollow tubular member;
(b) placing a fabric material in said mold;
(c) pressing said fabric material against said interior surface; and
(d) introducing a resin material in said mold to combine with said fabric material to form said tubular member.

19. The method of claim 18, further comprising applying a sub-atmospheric pressure in said mold to press said fabric material against said mold.

20. The method of claim 18, further comprising placing a bladder in said mold.

21. The method of claim 20, further comprising joining said bladder with said mold to form a substantially air tight region around said fabric material.

22. The method of claim 18, further comprising placing a pipe in said mold adjacent said fabric material for introducing said resin material into said mold.

23. The method of claim 18, further comprising forming at least one flute in said hollow tubular member.

24. The method of claim 18, further comprising separating said plurality of components to remove said hollow tubular member from said mold.

25. A method of forming a hollow tubular member, said method comprising:
(a) providing a hollow mold defining a surface residing inside an enclosure of the mold corresponding to a configuration of said hollow tubular member;
(b) placing a bladder in said mold;
(c) placing a pipe in said mold between said surface and said bladder for supplying a resin material in said mold.

26. The method of claim 25, further comprising placing a fabric material in said mold for forming said hollow tubular member between said surface and said bladder.

27. The method of claim 26, further comprising applying a sub-atmospheric pressure in said mold to press said fabric material against said mold and draw a resin material into said mold.

28. The method of claim 26, further comprising joining said bladder with said mold to form a substantially air tight region around said fabric material.

29. The method of claim 25, wherein said pipe comprises a helical slot for allowing said resin material to pass therethrough.

30. The method of claim 25, further comprising forming at least one flute in said hollow tubular member.

31. An apparatus for forming a hollow tubular member, said apparatus comprising:
a mold defining a surface for receiving a material for forming said hollow tubular member;
a flexible bladder positioned on an interior of said mold, said flexible bladder configured to expand to press said material against said mold; and
a pump for creating a pressure to cause said bladder to expand.

32. The apparatus of claim 31, further comprising a pipe for introducing a resin material in said mold.

33. The apparatus of claim 32, wherein said pipe extends along a majority length of said mold.

34. The apparatus of claim 32, wherein said pipe comprises at least one aperture for passing said resin material therethrough.

35. The apparatus of claim 34, wherein said at least one aperture comprises a helical slot extending along a length of said pipe.

36. The apparatus of claim 31, wherein said mold comprises a first portion corresponding to a first portion of said hollow tubular member, and a second portion corresponding to a second portion of said hollow tubular member, said first portion of said mold and said second portion of said mold being configured to be removably joined together to form said hollow tubular member in a single piece.

37. The apparatus of claim 31, wherein said flexible bladder comprises a cylindrical member having openings at opposing ends, said bladder being attachable to opposing ends of said mold.

38. The apparatus of claim 31, wherein said bladder is attachable to said mold to form a substantially air tight region.

39. The apparatus of claim 31, wherein said pump is attached between said mold and said bladder to create a sub-atmospheric pressure in said substantially air tight region.

40. An apparatus for forming a hollow tubular member, said apparatus comprising:
a mold defining a surface for receiving a fabric material for forming said hollow tubular member, said mold comprising a first portion corresponding to a first portion of said hollow tubular member, and a second portion corresponding to a second portion of said hollow tubular member, said first portion of said mold and said second portion of said mold being configured to be removably joined together to form said hollow tubular member in a single piece; and
means for pressing said fabric material against said surface with said mold remaining in a stationary position.

41. The apparatus of claim 40, wherein said means for pressing said fabric material against said surface comprises a flexible bladder.

42. The apparatus of claim 41, wherein said means for pressing said fabric material against said surface further comprises a pump for creating a pressure to cause said bladder to expand.

43. The apparatus of claim 41, wherein said flexible bladder is joined with said mold to form a substantially air tight region.

44. The apparatus of claim 40, further comprising a pipe for introducing a resin material in said mold, wherein said pipe comprises at least one aperture for passing said resin material therethrough.

45. The apparatus of claim 44, wherein said at least one aperture comprises a helical slot extending along a length of said pipe.

46. An apparatus for forming a hollow tubular member, said apparatus comprising:
a mold defining a surface for receiving a fabric material and resin for forming said hollow tubular member;
a pipe extending along a majority length of said mold, said pipe comprising at least one aperture configured for passing said resin therethrough for introducing said resin into said fabric material.

47. The apparatus of claim 46, further comprising a flexible bladder positioned on an interior of said mold, said flexible bladder configured to expand to press said material against said mold.

48. The apparatus of claim 47, wherein said flexible bladder is joined with said mold to form a substantially air tight region for receiving said fabric material and resin.

49. The apparatus of claim 47, further comprising a pump for creating a pressure to cause said bladder to expand.

50. The apparatus of claim 46, wherein said at least one aperture comprises a helical slot extending along a length of said pipe.

51. The method of claim 1, further comprising the steps of:
(d) providing said mold in a plurality of components, said plurality of components being configured to be joined together;
(e) placing a bladder in said mold;
(f) joining said bladder with said mold to form a substantially air tight region around said material;
(g) placing a pipe in said mold adjacent said material and between the surface of the mold and the bladder, for introducing said resin material into said mold, to combine with said material to form said tubular member;
(h) allowing said material and said resin material to cure to form said hollow tubular member;
(I) removing said hollow tubular member from said mold;
(j) forming at least one flute in said hollow tubular member;
wherein the step of applying a sub-atmospheric pressure in said mold further comprises expanding said bladder to press said material against said mold;
wherein the step of placing a material in said mold comprises placing a fabric material in said mold;
wherein said sub-atmospheric pressure is applied to said substantially air tight region;
wherein applying said sub-atmospheric pressure in said mold to press said material against said mold comprises expanding said bladder;
wherein the step of providing a mold further comprising providing a mold comprised of a plurality of components joined together to define an interior surface corresponding to an exterior surface of said hollow tubular member;
wherein the step of placing a material in said mold further comprises pressing said material against the interior surface of the mold;
wherein the pipe comprises a helical slot for allowing said resin material to pass therethrough.

52. The apparatus of claim 31, further comprising a pipe for introducing a resin material in said mold;
wherein said pipe extends along a majority length of said mold;
wherein said pipe comprises at least one aperture for passing said resin material therethrough;
wherein said at least one aperture comprises a helical slot extending along a length of said pipe;
wherein said mold comprises a first portion corresponding to a first portion of said hollow tubular member, and a second portion corresponding to a second portion of said hollow tubular member, said first portion of said mold and said second portion of said mold being configured to be removably joined together to form said hollow tubular member in a single piece;
wherein said flexible bladder comprises a cylindrical member having openings at opposing ends, said bladder being attachable to opposing ends of said mold;
wherein said bladder is attachable to said mold to form a substantially air tight region;
wherein said pump is attached between said mold and said bladder to create a sub-atmospheric pressure in said substantially air tight region;
wherein the material is a fabric material, the apparatus further comprising a means for pressing said fabric material against said surface with said mold remaining in a stationary position.
